(19) United States
(12) Patent Application Publication
(10) Pub. No.: US 2014/0195578 A1
(43) Pub. Date: Jul. 10, 2014

(54) FAST FOURIER TRANSFORM CIRCUIT

(71) Applicant: FUJITSU LIMITED, Kawasaki-shi (JP)

(72) Inventors: Tetsuya MUKUNOKI, Kawasaki (JP); Akifumi MUTOU, Gifu (JP)

(73) Assignee: FUJITSU LIMITED, Kawasaki-shi (JP)

(21) Appl. No.: 14/207,956

(22) Filed: Mar. 13, 2014

Related U.S. Application Data
(63) Continuation of application No. PCT/JP2011/071661, filed on Sep. 22, 2011.

(51) Int. Cl. G06F 17/14

(52) U.S. Cl. CPC G06F 17/142
USPC 708/404

(57) ABSTRACT

A multiplexer receives a plurality of data streams transmitted in parallel on a time axis, and outputs partial data of each data stream every unit time in determined data stream order. A butterfly computation section at a first stage receives as second input data the partial data outputted from the multiplexer. A delay section corresponding to the butterfly computation section at the first stage receives in the data stream order the partial data outputted from the multiplexer, delays the partial data, and outputs the partial data as first input data for the butterfly computation section at the first stage.

### CROSS-REFERENCE TO RELATED APPLICATION

This application is a continuation application of International Application PCT/JP2011/071661 filed on Sep. 22, 2011 which designated the U.S., the entire contents of which are incorporated herein by reference.

### FIELD

The embodiment discussed herein is related to a fast Fourier transform circuit.

### BACKGROUND

Pipeline fast Fourier transform (hereinafter referred to as FFT) circuits are used in various fields of industry and are used in wired or radio communication apparatus, AV (Audio/Visual) systems, and the like.

In order to process stream data on a plurality of channels which is a plurality of data streams transmitted in parallel on a time axis, the following technique has traditionally been used. One pipeline FFT circuit is used, input switching is performed on the basis of SISO (Single Input Single Output), and data is processed according to channels. In recent years, however, there has been a growing demand for processing stream data on a plurality of channels at the same time. This is represented by radio MIMO (Multi Input Multi Output).

The following technique for processing stream data on a plurality of channels at the same time is known. Pipeline FFT circuits are placed according to channels and the pipeline FFT circuits process stream data on a plurality of channels independently of one another.

Japanese Laid-open Patent Publication No. 06-342449

With the conventional technique for processing stream data on a plurality of channels, however, pipeline FFT circuits are placed according to channels. This increases circuit scale.

### SUMMARY

According to an aspect, there is provided a fast Fourier transform circuit which includes a multiplexer which receives a plurality of data streams transmitted in parallel on a time axis and which outputs partial data of each data stream every unit time in determined data stream order, a plurality of delay sections which delay and output input data, butterfly computation sections which correspond to the plurality of delay sections in number, each of which receives output data from a corresponding delay section as first input data, each of which computes a sum of and a difference between the first input data and second input data, and each of which outputs one computation result or the second input data to the corresponding delay section, and multiplication sections each of which multiplies an other computation result obtained by each of the butterfly computation sections or output data from the corresponding delay section and a twiddle factor together and each of which outputs a multiplication result as the second input data for a butterfly computation section at a next stage, in which the butterfly computation section at a first stage receives as the second input data the partial data outputted from the multiplexer, and in which a delay section of the plurality of delay sections corresponding to the butterfly computation section at the first stage receives the partial data outputted from the multiplexer in the data stream order, delays the partial data, and outputs the partial data as the first input data for the butterfly computation section at the first stage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an FFT circuit according to an embodiment;

FIG. 2 illustrates an example of stream data;

FIG. 3 illustrates a state of an example of a signal in each section in the FFT circuit at the time of a multiplied clock signal rising 12 times;

FIG. 4 illustrates a state of an example of a signal in each section in the FFT circuit at the time of the multiplied clock signal rising 18 times;

FIG. 5 illustrates a state of an example of a signal in each section in the FFT circuit at the time of the multiplied clock signal rising 21 times;

FIG. 6 illustrates a state of an example of a signal in each section in the FFT circuit at the time of the multiplied clock signal rising 22 times; and

FIG. 7 illustrates a state of an example of a signal in each section in the FFT circuit at the time of the multiplied clock signal rising 23 times.

### DESCRIPTION OF EMBODIMENT

An embodiment will now be described with reference to the accompanying drawings, wherein like reference numerals refer to like elements throughout.

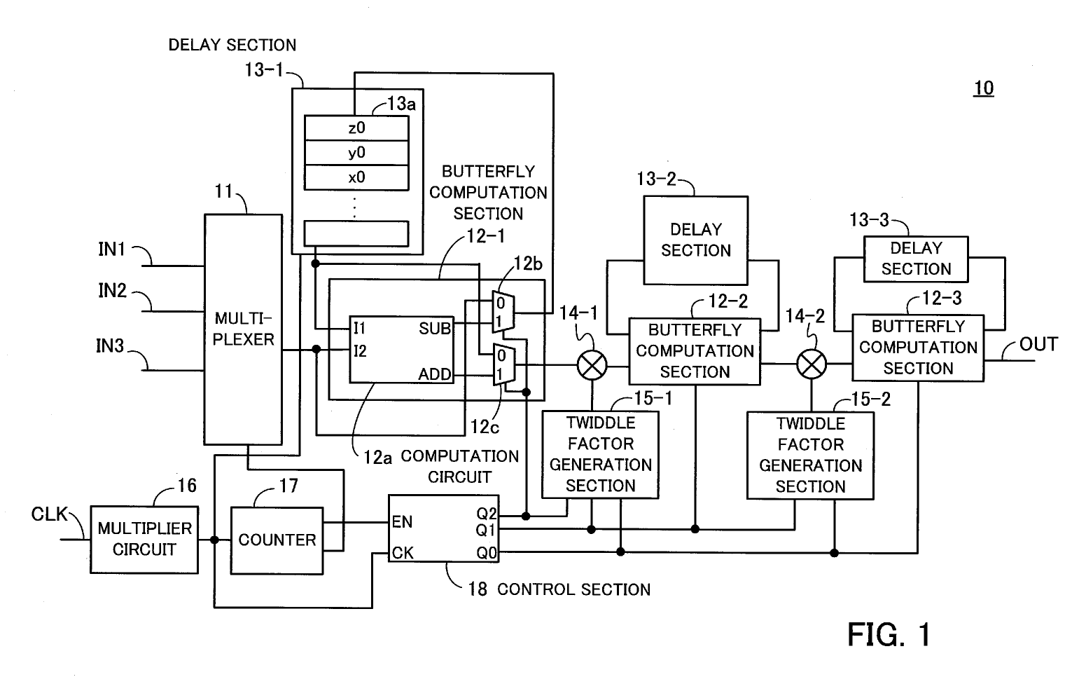

FIG. 1 illustrates an example of an FFT circuit according to an embodiment.

An FFT circuit 10 includes a multiplexer 11, butterfly computation sections 12-1, 12-2, and 12-3, delay sections 13-1, 13-2, and 13-3, multiplication sections 14-1 and 14-2, twiddle factor generation sections 15-1 and 15-2, a multiplier circuit 16, a counter 17, and a control section 18.

The FFT circuit 10 according to this embodiment is a pipeline FFT circuit which performs Fourier transform by the use of a butterfly computation. Detailed description of a computation algorithm will be omitted. A pipeline FFT circuit divides the length of data on which FFT is performed into lengths which are equal to its divisors, and performs computation. If data length is 8, 8 is expressed as 2×2×2. Therefore, an FFT computation is performed at three stages at which data lengths are 8, 4, and 2 which are divisors of 8. With the FFT circuit 10 illustrated in FIG. 1, the length of data on which FFT is performed is 8. However, the length of data on which FFT is performed is not limited to 8.

The multiplexer 11 receives a plurality of data streams transmitted in parallel on a time axis (hereinafter referred to as stream data). In the example of FIG. 1, the multiplexer 11 receives three pieces of stream data from input signal lines IN1, IN2, and IN3.

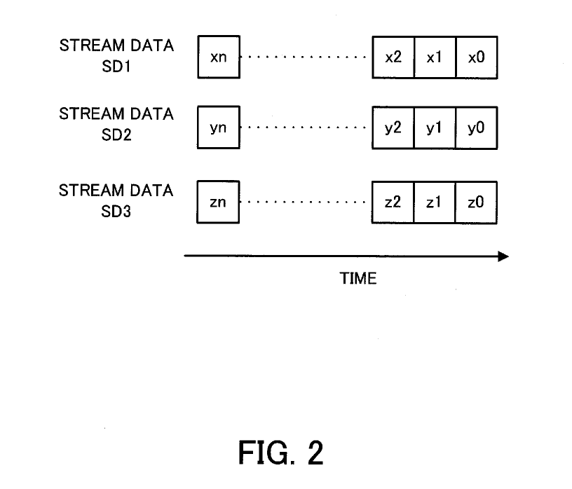

FIG. 2 illustrates an example of stream data. In FIG. 2, a horizontal axis is a time axis.

In the example of FIG. 2, three pieces of stream data SD1, SD2, and SD3 are indicated. The stream data SD1 includes partial data x0, x1, x2, . . . , and xn. The stream data SD2 includes partial data y0, y1, y2, . . . , and yn. The stream data SD3 includes partial data z0, z1, z2, . . . , and zn. The amount of each piece of partial data is, for example, one word. The stream data SD1, SD2, and SD3 are image data, audio data, or the like and there is no special limitation on the type of the stream data SD1, SD2, and SD3.

For example, the multiplexer 11 receives the stream data SD1 via the input signal line IN1, receives the stream data SD2 via the input signal line IN2, and receives the stream data SD3 via the input signal line IN3. The stream data SD1, SD2, and SD3 are supplied from the outside of the FFT circuit 10 in synchronization with a clock signal. The multiplexer 11 outputs partial data included in each piece of stream data every unit time in determined stream data order.

For example, the multiplexer 11 outputs a piece of partial data included in each piece of stream data every unit time in the order of the stream data SD1, SD2, and SD3. For example, the multiplexer 11 which receives the stream data SD1 through SD3 illustrated in FIG. 2 outputs partial data every unit time in the order of the partial data x0, y0, z0, x1, y1, z1, . . . , xn, yn, and zn.

The unit time is a cycle of a clock signal whose frequency is multiplied by the number of pieces of stream data by the multiplier circuit 16.

The number of the butterfly computation sections 12-1 through 12-3 corresponds to that of the delay sections 13-1 through 13-3.

The number of the butterfly computation sections 12-1 through 12-3 and the delay sections 13-1 through 13-3 depends on the number of pieces of partial data included in the stream data SD1, SD2, or SD3 on which FFT is performed (length of data on which FFT is performed). If the number of pieces of partial data is 2³(=8), then the three butterfly computation sections 12-1 through 12-3 are included as illustrated in FIG. 1. If the number of pieces of partial data is 2⁴(=16), then four butterfly computation sections are included.

The butterfly computation section 12-1 receives data outputted from the corresponding delay section 13-1 as first input data and computes the sum of and the difference between the first input data and second input data. The butterfly computation section 12-1 then outputs one computation result or the second input data to the corresponding delay section 13-1. Similarly, the butterfly computation section 12-2 receives data outputted from the corresponding delay section 13-2 as first input data and computes the sum of and the difference between the first input data and second input data. The butterfly computation section 12-2 then outputs one computation result or the second input data to the corresponding delay section 13-2. The butterfly computation section 12-3 receives data outputted from the corresponding delay section 13-3 as first input data and computes the sum of and the difference between the first input data and second input data. The butterfly computation section 12-3 then outputs one computation result or the second input data to the corresponding delay section 13-3.

The butterfly computation section 12-1 includes a computation circuit 12a and selectors 12b and 12c. The computation circuit 12a receives via a terminal I1 data outputted from the delay section 13-1 and receives via a terminal I2 partial data outputted from the multiplexer 11. The computation circuit 12a then computes a sum of and a difference between them, outputs the difference from a terminal SUB, and outputs the sum from a terminal ADD.

Partial data outputted from the multiplexer 11 and a computation result outputted from the terminal SUB of the computation circuit 12a are inputted to the selector 12b. The selector 12b selects one of the two pieces of input data and outputs it to the delay section 13-1, according to a value of a bit outputted from a terminal Q2 of the control section 18. When a bit outputted from the terminal Q2 of the control section 18 is “0”, the selector 12b selects and outputs the partial data outputted from the multiplexer 11. When a bit outputted from the terminal Q2 of the control section 18 is “1”, the selector 12b selects and outputs the computation result outputted from the terminal SUB of the computation circuit 12a.

Data outputted from the delay section 13-1 and a computation result outputted from the terminal ADD of the computation circuit 12a are inputted to the selector 12c. The selector 12c selects one of the two pieces of input data and outputs it to the multiplication section 14-1, according to a value of a bit outputted from the terminal Q2 of the control section 18. When a bit outputted from the terminal Q2 of the control section 18 is “0”, the selector 12c selects and outputs the data outputted from the delay section 13-1. When a bit outputted from the terminal Q2 of the control section 18 is “1”, the selector 12c selects and outputs the computation result outputted from the terminal ADD of the computation circuit 12a.

The butterfly computation sections 12-2 and 12-3 include the same circuits that the butterfly computation section 12-1 includes, but they are not illustrated in FIG. 1. However, the selector 12b of the butterfly computation section 12-2 receives a computation result outputted from the multiplication section 14-1 in place of partial data outputted from the multiplexer 11. In addition, the selector 12b of the butterfly computation section 12-3 receives a computation result outputted from the multiplication section 14-2 in place of partial data outputted from the multiplexer 11.

Furthermore, the butterfly computation section 12-3 at the final stage is connected to an output signal line OUT, and outputs an FFT result to the outside of the FFT circuit 10 via the output signal line OUT.

The delay sections 13-1 through 13-3 delay and output input data. The number of the delay sections 13-1 through 13-3 corresponds to that of the butterfly computation sections 12-1 through 12-3. In the example of FIG. 1, the three delay sections 13-1 through 13-3 are included.

The delay section 13-1 corresponding to the butterfly computation section 12-1 at the first stage includes a shift register 13a, shifts data accepted in synchronization with a multiplied clock signal generated by the multiplier circuit 16, delays the data by determined time, and outputs it. The delay sections 13-2 and 13-3 include the same shift register that the delay section 13-1 includes, but they are not illustrated in FIG. 1.

Furthermore, the delay section 13-1 receives partial data outputted from the multiplexer 11 in the above stream data order, delays the partial data, and outputs the partial data to the butterfly computation section 12-1 at the first stage as first input data. FIG. 1 illustrates a state in which partial data is stored in the shift register 13a of the delay section 13-1 in the order of x0, y0, and z0.

In the delay sections 13-1 through 13-3 which output first input data to the butterfly computation sections 12-1 through 12-3 respectively, delay time is set in the following way according to the number of pieces of stream data and partial data. That is to say, delay time is set so that first input data and second input data each including partial data which belongs to the same stream data will be inputted to the butterfly computation sections 12-1 through 12-3.

For example, when the partial data x4 of the stream data SD1 is inputted to the butterfly computation section 12-1, delay time is set so that the partial data x0 of the same stream data SD1 will be outputted from the delay section 13-1.

If the number of pieces of partial data is 8, then the three delay sections 13-1 through 13-3 are included. Delay time is 4×(number of pieces of stream data)×(unit time) in the delay section 13-1. In addition, delay time is 2×(number of pieces of stream data)×(unit time) in the delay section 13-2 and delay time is 1×(number of pieces of stream data)×(unit time) in the delay section 13-3.

Accordingly, if number of pieces of stream data is 3, then delay time is 12×(unit time) in the delay section 13-1, delay time is 6×(unit time) in the delay section 13-2, and delay time is 3×(unit time) in the delay section 13-3.

As a result, the butterfly computation sections 12-1 through 12-3 at individual stages can perform butterfly computation by the use of partial data of the same stream data.

The multiplication section 14-1 multiplies one of computation results outputted from the butterfly computation section 12-1 or data outputted from the delay section 13-1 by a twiddle factor according to a result of selection by the selector 12c and outputs a result. Similarly, the multiplication section 14-2 multiplies one of computation results outputted from the butterfly computation section 12-2 or data outputted from the delay section 13-2 by a twiddle factor according to a result of selection by the selector 12c and outputs a result. Data outputted from the multiplication section 14-1 or 14-2 is used as second input data for the butterfly computation section 12-2 or 12-3 at the next stage.

The twiddle factor generation sections 15-1 and 15-2 generate twiddle factors. The twiddle factor generation sections 15-1 and 15-2 update twiddle factors in response to a signal from the control section 18. A twiddle factor is given by

W_{N}ⁿ=(exp^{-j(2π/N)})ⁿ

N in the above expression is the length of data for FFT at each stage. With the FFT circuit 10 of FIG. 1 which performs an FFT computation of data whose length is 8, N is 8 in the twiddle factor generation section 15-1 that generates a twiddle factor by which output from the butterfly computation section 12-1 at the first stage is multiplied. N is 4 in the twiddle factor generation section 15-2 that generates a twiddle factor by which output from the butterfly computation section 12-2 at the second stage is multiplied.

In addition, n in the above expression is a decimal stage state number and depends on bits outputted from terminals Q0, Q1, and Q2 of the control section 18. Hereinafter bits outputted from the terminals Q0, Q1, and Q2 will be indicated by bits Q0, Q1, and Q2 respectively. A bit Q0 is a least significant bit and a bit Q2 is a most significant bit.

If N=8, stage state number n is 0 through 7. If N=4, stage state number n is 0 through 3.

For example, if three bits Q2, Q1, and Q0 are binary numbers and are (000), then n=0 and W₈°=W₄°=1. Furthermore, if N=8, W₈ⁿ is “1” when n is 4 through 7. If N=4, W₄ⁿ is “1” when n is 2 or 3.

The multiplier circuit 16 receives via a clock signal line CLK a clock signal which determines a timing at which input is supplied to the multiplexer 11, and generates a multiplied clock signal by multiplying a frequency of the clock signal by the number of pieces of stream data. A cycle of the multiplied clock signal is the above unit time. Accordingly, conversely speaking, the clock signal has a cycle obtained by multiplying the unit time by the number of pieces of stream data.

The counter 17 has the function of generating a selection signal for the multiplexer 11 updated in a cycle of a multiplied clock signal and outputting to the control section 18 a control signal (hereinafter referred to as an enable signal) obtained by frequency-dividing the multiplied clock signal by the number of pieces of stream data. If the number of pieces of stream data is 3, the counter 17 is a 3-digit binary counter and counts a rising edge or a falling edge of the multiplied clock signal. When a count value is 2 ((10) in binary notation), the counter 17 outputs “1” to the control section 18.

Furthermore, the counter 17 outputs a count value as a selection signal to the multiplexer 11. A count value is updated in the cycle of the multiplied clock signal, so the multiplexer 11 selects and outputs partial data of the stream data SD1 through SD3 in the cycle of the multiplied clock signal.

If the number of pieces of partial data on which FFT is performed is 8, the control section 18 is a 3-bit binary counter. The control section 18 receives an enable signal outputted from the counter 17 with a terminal EN. When the enable signal is “1”, the control section 18 counts a rising edge or a falling edge of a multiplied clock signal inputted to a terminal CK. The control section 18 then transmits the most significant bit Q2 of a count value to the butterfly computation section 12-1 and the twiddle factor generation section 15-1.

In addition, the control section 18 transmits the second bit Q1 of the count value to the butterfly computation section 12-2 and the twiddle factor generation sections 15-1 and 15-2 and transmits the least significant bit Q0 of the count value to the butterfly computation section 12-3 and the twiddle factor generation sections 15-1 and 15-2.

As a result, the twiddle factor generation sections 15-1 and 15-2 update twiddle factors at a timing (that is to say, in a cycle of an original clock signal) corresponding to an enable signal.

With the above FFT circuit 10 according to this embodiment, as will be described later in detail, FFT computations of plural pieces of stream data can be performed according to partial data by one pipeline FFT circuit. That is to say, FFT can be performed on plural pieces of stream data by the use of a small-scale circuit.

Furthermore, with the FFT circuit 10 according to this embodiment partial data is outputted from the multiplexer 11 in a cycle of a multiplied clock signal obtained by multiplying a frequency of an original clock signal by the number of pieces of stream data. In addition, a twiddle factor is updated in a cycle of the clock signal. As a result, FFT can be performed on plural pieces of stream data at high speed by one pipeline FFT circuit 10.

The operation of the FFT circuit 10 according to this embodiment will now be described.

In the following description it is assumed that three pieces of stream data SD1 through SD3 like those illustrated in FIG. 2 are inputted from the outside of the FFT circuit 10 to the multiplexer 11 via the input signal lines IN1 through IN3, respectively, and that the FFT circuit 10 operates in synchronization with a timing at which a clock signal or a multiplied clock signal rises.

The multiplexer 11 receives the stream data SD1 through SD3 according to partial data in synchronization with the clock signal. First, the multiplexer 11 receives first partial data x0, y0, and z0 of the stream data SD1 through SD3, respectively, at some timing at which the clock signal rises.

A count value of the counter 17 is (00) in an initial state. The multiplexer 11 selects and outputs the first partial data x0 of the stream data SD1 with this count value as a selection signal. Furthermore, in the initial state, bits Q2, Q1, and Q0 outputted from the control section 18 are (000) and the selector 12b of the butterfly computation section 12-1 outputs the partial data x0.

As stated above, if the bits Q2, Q1, and Q0 are (000), then twiddle factors generated by the twiddle factor generation sections 15-1 and 15-2 are “1”.

When the multiplied clock signal generated by the multiplier circuit 16 rises to an H (High) level, a count value of the counter 17 becomes (01). As a result, the multiplexer 11 selects and outputs the first partial data y0 of the stream data SD2. A count value of the counter 17 is (01), so an enable signal outputted from the counter 17 to the control section 18 remains at “0”. Accordingly, the bits Q2, Q1, and Q0 outputted from the control section 18 also remain at (000) and the selector 12b of the butterfly computation section 12-1 outputs the partial data y0.

In addition, at this time the shift register 13a of the delay section 13-1 accepts the partial data x0 outputted at the preceding timing from the butterfly computation section 12-1 in synchronization with a rise of the multiplied clock signal.

When the multiplied clock signal rises next, a count value of the counter 17 becomes (10). As a result, the multiplexer 11 selects and outputs the first partial data z0 of the stream data SD3. Furthermore, when a count value of the counter 17 is (10), an enable signal outputted from the counter 17 to the control section 18 is “1”. However, the bits Q2, Q1, and Q0 outputted from the control section 18 remain at (000) until the multiplied clock signal rises next. Accordingly, the selector 12b of the butterfly computation section 12-1 outputs the partial data z0.

In addition, at this time the shift register 13a of the delay section 13-1 shifts the partial data x0 which has already been accepted to the next stage and accepts the partial data y0 in synchronization with a rise of the multiplied clock signal.

When the multiplied clock signal rises next, the same process is performed. That is to say, the partial data z0 is accepted into the shift register 13a and the shift register 13a goes into a state illustrated in FIG. 1. Furthermore, the multiplied clock signal is inputted in a state in which the enable signal is “1”, so the control section 18 does count. As a result, the bit Q0 becomes “1”. However, the bits Q1 and Q2 remain at “0”. Accordingly, the selector 12b of the butterfly computation section 12-1 selects partial data x1 outputted from the multiplexer 11 and outputs it to the delay section 13-1.

This process is repeated. When the multiplied clock signal rises 12 times after the beginning of the process, the FFT circuit 10 goes into a state described below.

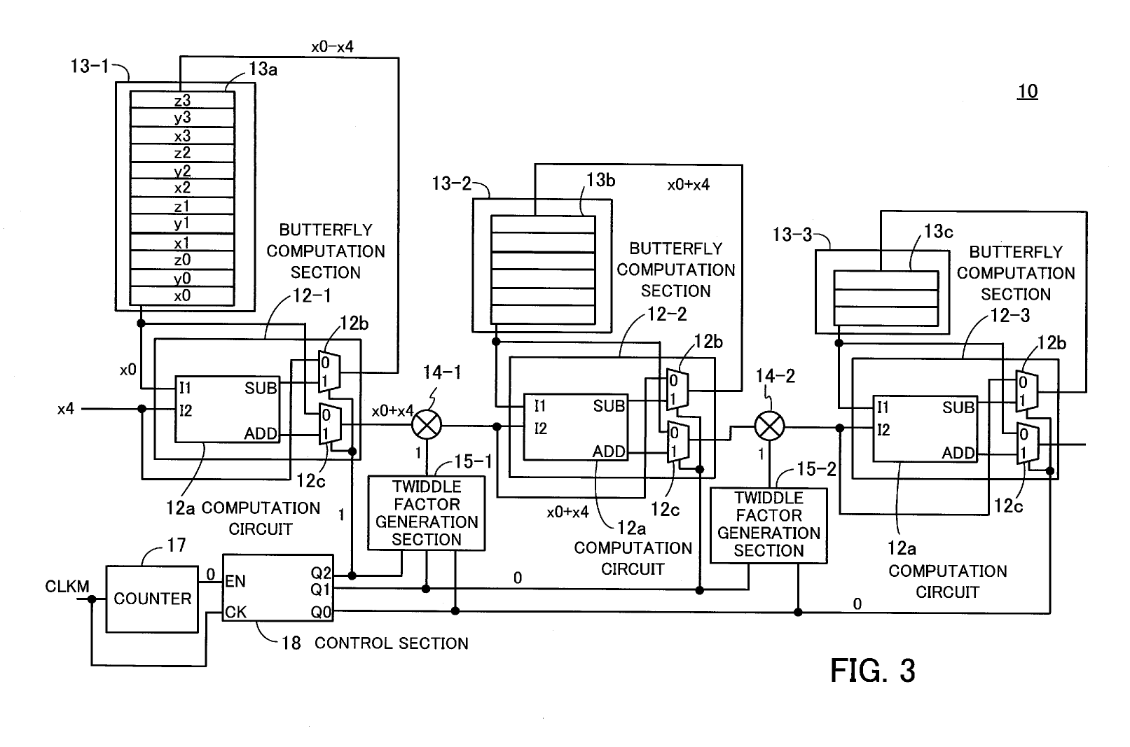

FIG. 3 illustrates a state of an example of a signal in each section in the FFT circuit at the time of the multiplied clock signal rising 12 times. The multiplexer 11, the multiplier circuit 16, and the like illustrated in FIG. 1 are not illustrated in FIG. 3. Furthermore, the multiplied clock signal is indicated by CLKM.

When the multiplied clock signal CLKM rises 12 times, the shift register 13a goes into a state illustrated in FIG. 3 and outputs the partial data x0. At this time the computation circuit 12a of the butterfly computation section 12-1 computes the sum (x0+x4) of and the difference (x0−x4) between the partial data x0 and partial data x4 outputted from the multiplexer 11.

In addition, count by the control section 18 has progressed in a state in which the multiplied clock signal CLKM has risen 12 times. As a result, the bits Q2, Q1, and Q0 are (100). Accordingly, the selector 12b of the butterfly computation section 12-1 outputs (x0−x4) to the delay section 13-1 and the selector 12c outputs (x0+x4) to the multiplication section 14-1.

Furthermore, as stated above, when the bits Q2, Q1, and Q0 inputted are (100), the twiddle factor generation section 15-1 outputs. Accordingly, the multiplication section 14-1 outputs (x0+x4). The bit Q1 inputted as a selection signal is “0”, so the selector 12b of the butterfly computation section 12-2 at the next stage outputs (x0+x4) to the delay section 13-2.

At this time first input data supplied from the delay section 13-2 or 13-3 is indefinite, so output from the computation circuit 12a of the butterfly computation section 12-2 or 12-3 is still in an indefinite state.

The process progresses further. When the multiplied clock signal CLKM rises 18 times after the beginning of the process, the FFT circuit 10 goes into a state described below.

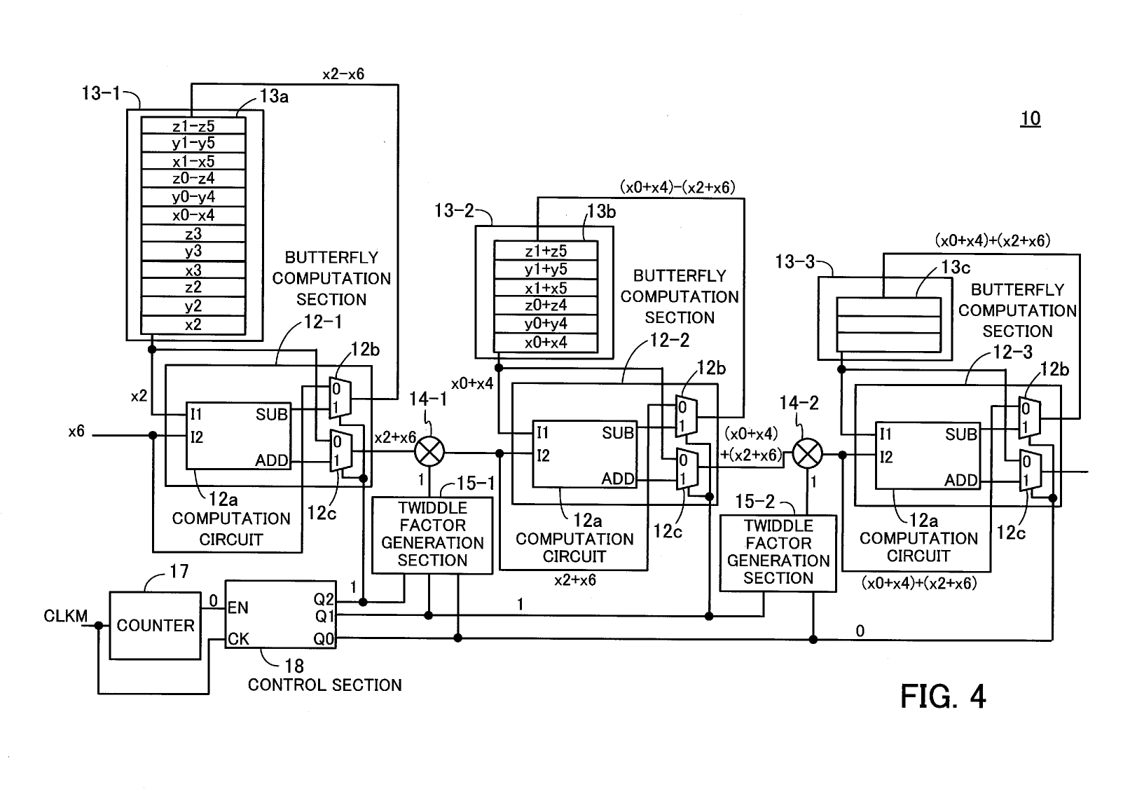

FIG. 4 illustrates a state of an example of a signal in each section in the FFT circuit at the time of the multiplied clock signal rising 18 times.

When the multiplied clock signal CLKM rises 18 times, the shift register 13a goes into a state illustrated in FIG. 4 and outputs partial data x2. At this time the computation circuit 12a of the butterfly computation section 12-1 computes the sum (x2+x6) of and the difference (x2−x6) between the partial data x2 and partial data x6 outputted from the multiplexer 11.

In addition, count by the control section 18 has progressed in a state in which the multiplied clock signal CLKM has risen 18 times. As a result, the bits Q2, Q1, and Q0 are (110). Accordingly, the selector 12b of the butterfly computation section 12-1 outputs (x2−x6) to the delay section 13-1 and the selector 12c outputs (x2+x6) to the multiplication section 14-1.

Furthermore, as stated above, when the bits Q2, Q1, and Q0 inputted are (110), the twiddle factor generation section 15-1 also outputs “1”. Accordingly, the multiplication section 14-1 outputs (x2+x6).

When the multiplied clock signal CLKM rises 18 times, a shift register 13b included in the delay section 13-2 corresponding to the butterfly computation section 12-2 at the second stage goes into a state illustrated in FIG. 4, and outputs (x0+x4). At this time the computation circuit 12a of the butterfly computation section 12-2 computes the sum ((x0+x4)+(x2+x6)) of and the difference ((x0+x4)−(x2+x6)) between (x0+x4) and (x2+x6) outputted from the multiplication section 14-1.

The bit Q1 outputted from the control section 18 is “1”, so the selector 12b of the butterfly computation section 12-2 outputs (x0+x4)−(x2+x6) to the delay section 13-2 and the selector 12c outputs (x0+x4)+(x2+x6) to the multiplication section 14-2.

Furthermore, when the bits Q1 and Q0 inputted are (10), the twiddle factor generation section 15-2 outputs “1”. Accordingly, the multiplication section 14-2 outputs (x0+x4)+(x2+x6). The bit Q0 inputted as a selection signal is “0”, so the selector 12b of the butterfly computation section 12-3 at the next stage outputs (x0+x4)+(x2+x6) to the delay section 13-3.

At this time first input data outputted from the delay section 13-3 to the butterfly computation section 12-3 is indefinite, so output from the computation circuit 12a of the butterfly computation section 12-3 is still in an indefinite state.

The process progresses further. When the multiplied clock signal CLKM rises 21 times after the beginning of the process, the FFT circuit 10 goes into a state described below.

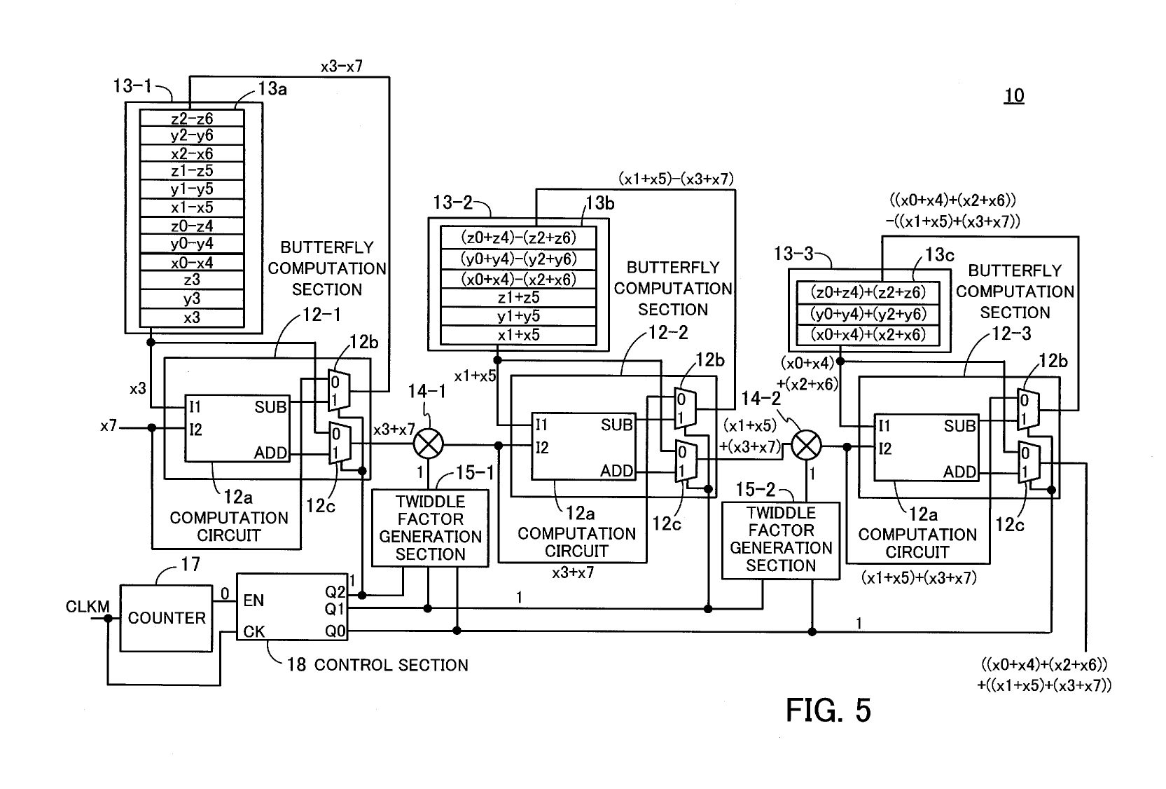

FIG. 5 illustrates a state of an example of a signal in each section in the FFT circuit at the time of the multiplied clock signal rising 21 times.

When the multiplied clock signal CLKM rises 21 times, the shift register 13a goes into a state illustrated in FIG. 5 and outputs partial data x3. At this time the computation circuit 12a of the butterfly computation section 12-1 computes the sum (x3+x7) of and the difference (x3−x7) between the partial data x3 and partial data x7 outputted from the multiplexer 11.

In addition, count by the control section 18 has progressed in a state in which the multiplied clock signal CLKM has risen 21 times. As a result, the bits Q2, Q1, and Q0 are (111). Accordingly, the selector 12b of the butterfly computation section 12-1 outputs (x3−x7) to the delay section 13-1 and the selector 12c outputs (x3+x7) to the multiplication section 14-1. Furthermore, as stated above, when the bits Q2, Q1, and Q0 inputted are (111), the twiddle factor generation section 15-1 also outputs “1”. Accordingly, the multiplication section 14-1 outputs (x3+x7).

When the multiplied clock signal CLKM rises 21 times, the shift register 13b included in the delay section 13-2 corresponding to the butterfly computation section 12-2 at the second stage goes into a state illustrated in FIG. 5, and outputs (x1+x5). At this time the computation circuit 12a of the butterfly computation section 12-2 computes the sum ((x1+x5)+(x3+x7)) of and the difference ((x1+x5)−(x3+x7)) between (x1+x5) and (x3+x7) outputted from the multiplication section 14-1.

The bit Q1 outputted from the control section 18 is “1”, so the selector 12b of the butterfly computation section 12-2 outputs (x1+x5)−(x3+x7) to the delay section 13-2 and the selector 12c outputs (x1+x5)+(x3+x7) to the multiplication section 14-2.

Furthermore, when the bits Q1 and Q0 inputted are (11), the twiddle factor generation section 15-2 outputs “1”. Accordingly, the multiplication section 14-2 outputs (x1+x5)+(x3+x7).

When the multiplied clock signal CLKM rises 21 times, a shift register 13c included in the delay section 13-3 corresponding to the butterfly computation section 12-3 at the third stage (final stage) goes into a state illustrated in FIG. 5, and outputs (x0+x4)+(x2+x6). At this time the computation circuit 12a of the butterfly computation section 12-3 computes the sum of and the difference between ((x0+x4)+(x2+x6)) and ((x1+x5)+(x3+x7)) outputted from the multiplication section 14-2. The sum is ((x0+x4)+(x2+x6))+((x1+x5)+(x3+x7)) and the difference is ((x0+x4)+(x2+x6))−((x1+x5)+(x3+x7)).

The bit Q0 outputted from the control section 18 is “1”, so the selector 12b of the butterfly computation section 12-3 outputs ((x0+x4)+(x2+x6))−((x1+x5)+(x3+x7)) to the delay section 13-3 and the selector 12c outputs ((x0+x4)+(x2+x6))+((x1+x5)+(x3+x7)) as a first value of an FFT result of the stream data SD1.

When the multiplied clock signal CLKM rises next, the FFT circuit 10 goes into a state described below.

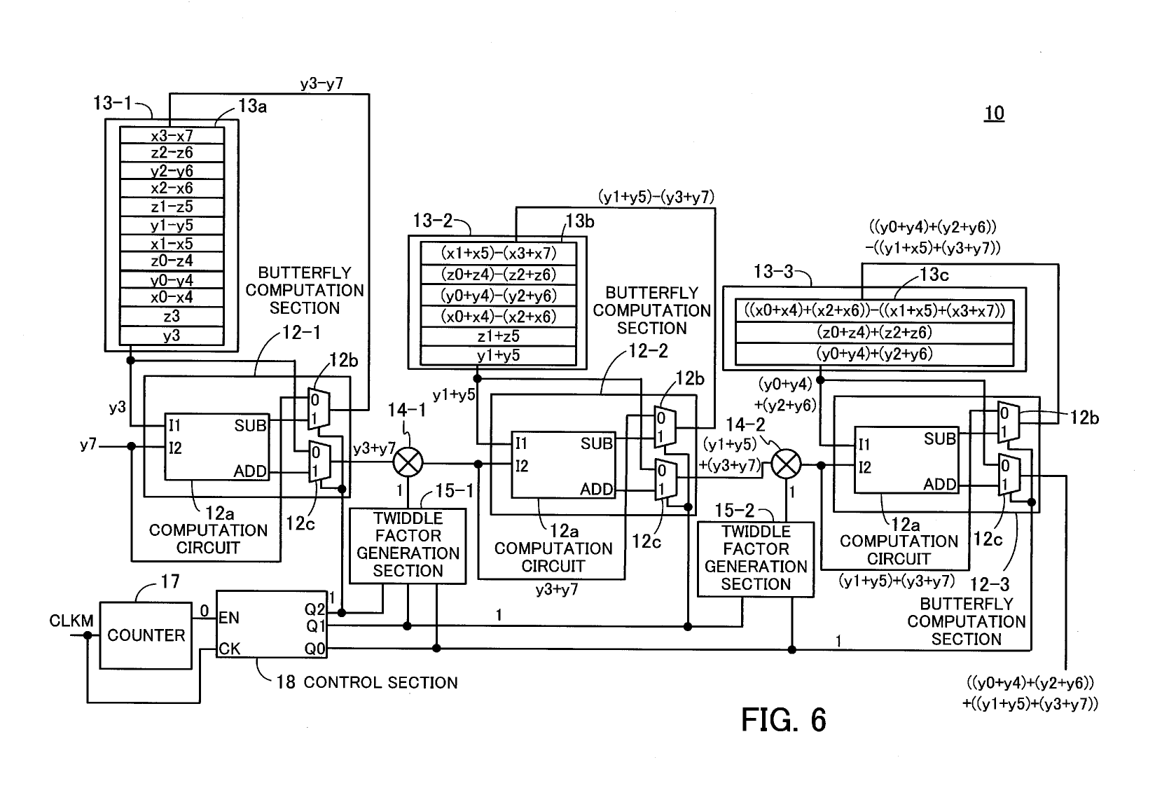

FIG. 6 illustrates a state of an example of a signal in each section in the FFT circuit at the time of the multiplied clock signal rising 22 times.

When the multiplied clock signal CLKM rises 22 times, the shift register 13a goes into a state illustrated in FIG. 6 and outputs partial data y3. At this time the computation circuit 12a of the butterfly computation section 12-1 computes the sum (y3+y7) of and the difference (y3−y7) between the partial data y3 and partial data y7 outputted from the multiplexer 11.

In addition, an enable signal is “0” in a state in which the multiplied clock signal CLKM has risen 22 times, so the bits Q2, Q1, and Q0 outputted from the control section 18 remain at (111). Accordingly, the selector 12b of the butterfly computation section 12-1 outputs (y3−y7) to the delay section 13-1 and the selector 12c outputs (y3+y7) to the multiplication section 14-1. The twiddle factor generation section 15-1 outputs “1”, so the multiplication section 14-1 outputs (y3+y7).

When the multiplied clock signal CLKM rises 22 times, the shift register 13b included in the delay section 13-2 corresponding to the butterfly computation section 12-2 at the second stage outputs (y1+y5). At this time the computation circuit 12a of the butterfly computation section 12-2 computes the sum ((y1+y5)+(y3+y7)) of and the difference ((y1+y5)−(y3+y7)) between (y1+y5) and (y3+y7) outputted from the multiplication section 14-1.

The bit Q1 outputted from the control section 18 is “1”, so the selector 12b of the butterfly computation section 12-2 outputs (y1+y5)−(y3+y7) to the delay section 13-2 and the selector 12c outputs (y1+y5)+(y3+y7) to the multiplication section 14-2.

Furthermore, the twiddle factor generation section 15-2 outputs “1”, so the multiplication section 14-2 outputs (y1+y5)+(y3+y7).

When the multiplied clock signal CLKM rises 22 times, the shift register 13c included in the delay section 13-3 corresponding to the butterfly computation section 12-3 outputs (y0+y4)+(y2+y6). At this time the computation circuit 12a of the butterfly computation section 12-3 computes the sum of and the difference between ((y0+y4)+(y2+y6)) and ((y1+y5)+(y3+y7)) outputted from the multiplication section 14-2. The sum is ((y0+y4)+(y2+y6))+((y1+y5)+(y3+y7)) and the difference is ((y0+y4)+(y2+y6))−((y1+y5)+(y3+y7)).

The bit Q0 outputted from the control section 18 is “1”, so the selector 12b of the butterfly computation section 12-3 outputs ((y0+y4)+(y2+y6))−((y1+y5)+(y3+y7)) to the delay section 13-3 and the selector 12c outputs ((y0+y4)+(y2+y6))+((y1+y5)+(y3+y7)) as a first value of an FFT result of the stream data SD2.

When the multiplied clock signal CLKM rises next, the FFT circuit 10 goes into a state described below.

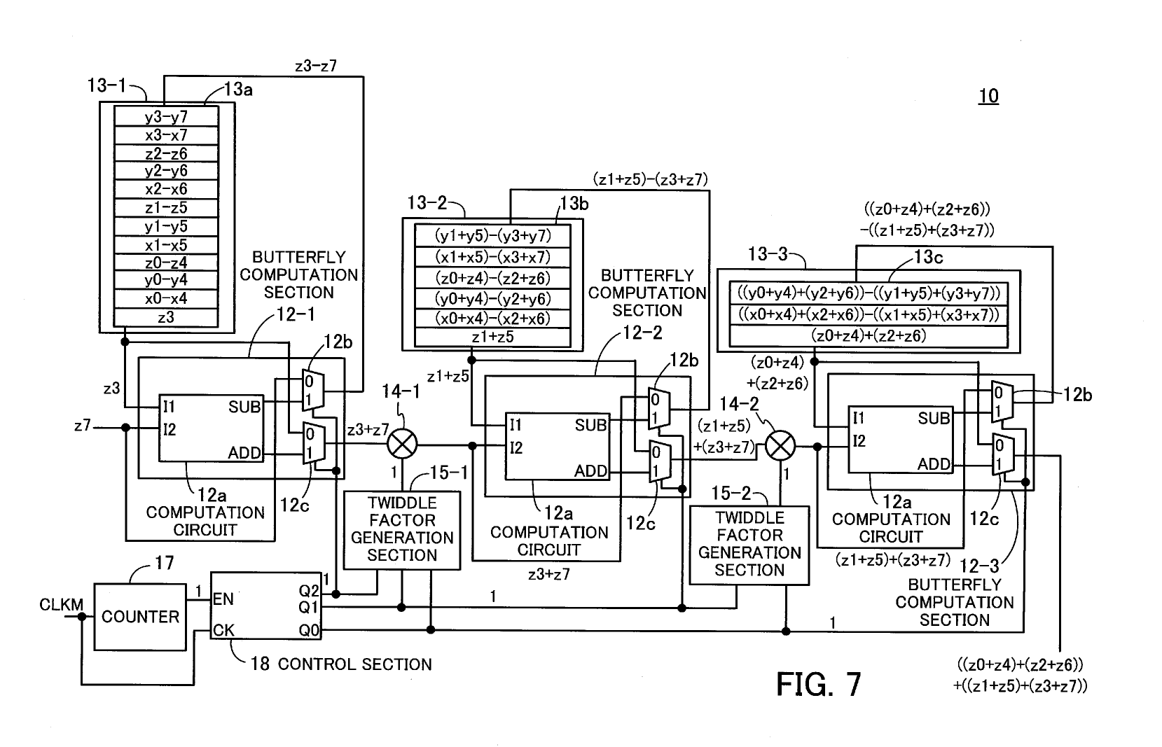

FIG. 7 illustrates a state of an example of a signal in each section in the FFT circuit at the time of the multiplied clock signal rising 23 times.

When the multiplied clock signal CLKM rises 23 times, the shift register 13a outputs partial data z3. At this time the computation circuit 12a of the butterfly computation section 12-1 computes the sum (z3+z7) of and the difference (z3−z7) between the partial data z3 and partial data z7 outputted from the multiplexer 11.

In addition, an enable signal is “1” in a state in which the multiplied clock signal CLKM has risen 23 times. However, the bits Q2, Q1, and Q0 outputted from the control section 18 remain at (111) until the multiplied clock signal CLKM rises next. Accordingly, the selector 12b of the butterfly computation section 12-1 outputs (z3−z7) to the delay section 13-1 and the selector 12c outputs (z3+z7) to the multiplication section 14-1. The twiddle factor generation section 15-1 outputs “1”, so the multiplication section 14-1 outputs (z3+z7).

When the multiplied clock signal CLKM rises 23 times, the shift register 13b included in the delay section 13-2 corresponding to the butterfly computation section 12-2 at the second stage outputs (z1+z5). At this time the computation circuit 12a of the butterfly computation section 12-2 computes the sum ((z1+z5)+(z3+z7)) of and the difference ((z1+z5)−(z3+z7)) between (z1+z5) and (z3+z7) outputted from the multiplication section 14-1.

The bit Q1 outputted from the control section 18 is “1”, so the selector 12b of the butterfly computation section 12-2 outputs (z1+z5)−(z3+z7) to the delay section 13-2 and the selector 12c outputs (z1+z5)+(z3+z7) to the multiplication section 14-2.

Furthermore, the twiddle factor generation section 15-2 outputs “1”, so the multiplication section 14-2 outputs (z1+z5)+(z3+z7).

When the multiplied clock signal CLKM rises 23 times, the shift register 13c included in the delay section 13-3 corresponding to the butterfly computation section 12-3 outputs (z0+z4)+(z2+z6). At this time the computation circuit 12a of the butterfly computation section 12-3 computes the sum of and the difference between ((z0+z4)+(z2+z6)) and ((z1+z5)+(z3+z7)) outputted from the multiplication section 14-2. The sum is ((z0+z4)+(z2+z6))+((z1+z5)+(z3+z7)) and the difference is ((z0+z4)+(z2+z6))−((z1+z5)+(z3+z7)).

The bit Q0 outputted from the control section is “1”, so the selector 12b of the butterfly computation section 12-3 outputs ((z0+z4)+(z2+z6))−((z1+z5)+(z3+z7)) to the delay section 13-3.

In addition, the selector 12c of the butterfly computation section 12-3 outputs ((z0+z4)+(z2+z6))+((z1+z5)+(z3+z7)) as a first value of an FFT result of the stream data SD3.

By performing this process, first FFT results of the stream data SD1 through SD3 are obtained.

By proceeding further with the above process, second and later FFT results of the stream data SD1 through SD3 are outputted in order from the selector 12c of the butterfly computation section 12-3 at the final stage.

As has been described, with the FFT circuit 10 according to this embodiment the multiplexer 11 outputs a piece of partial data included in a piece of stream data every unit time in determined stream data order. Furthermore, the delay section 13-1 corresponding to the butterfly computation section 12-1 at the first stage receives partial data in the stream data order, delays the partial data, and supplies the partial data to the butterfly computation section 12-1. The butterfly computation section 12-1 performs computation by the use of partial data outputted at that time from the multiplexer 11 and the delayed partial data.

As a result, FFT can be performed on plural pieces of stream data according to partial data by one pipeline FFT circuit 10. That is to say, FFT can be performed on plural pieces of stream data by a small-scale circuit.

In the above description the FFT circuit 10 to which a SDF (Single-Path Delay Feedback) technique is applied is used. However, another technique may be adopted. A pipeline FFT circuit which performs the same process is realized by adopting a MDC (Multi-Path Delay Commutator) technique or the like.

Furthermore, in the above description the FFT circuit 10 performs radix-2 FFT. However, a radix is not limited to 2.

The FFT circuit according to this embodiment which realizes the above process includes the multiplexer which receives plural pieces of stream data and which outputs partial data included in each piece of stream data every unit time in determined stream data order. In addition, the butterfly computation section at the first stage receives as one input data partial data outputted from the multiplexer. Furthermore, the delay section corresponding to the butterfly computation section at the first stage receives partial data outputted from the multiplexer in the above stream data order, delays the partial data, and outputs the partial data as other input data to the butterfly computation section at the first stage.

In addition, delay time given by a delay section is set according to the number of pieces of stream data and the number of pieces of partial data so that the delay section will output to a butterfly computation section one piece of data including partial data which belongs to the same stream data where partial data included in the other piece of data inputted to the butterfly computation section belongs. As illustrated in FIG. 3, for example, when the partial data x4 of the stream data SD1 is inputted to the butterfly computation section 12-1, delay time is set so that the partial data x0 of the same stream data SD1 will be outputted from the delay section 13-1.

Moreover, the FFT circuit according to this embodiment which realizes the above process includes the multiplier circuit which receives a clock signal having a cycle obtained by multiplying unit time by the number of pieces of stream data and which generates a multiplied clock signal by multiplying a frequency of the clock signal by the number of the pieces of stream data. Furthermore, the FFT circuit includes the counter which generates a selection signal for the multiplexer updated in a cycle of a multiplied clock signal and which generates a control signal obtained by frequency-dividing the multiplied clock signal by the number of pieces of stream data. In addition, the FFT circuit includes the twiddle factor generation section which updates a twiddle factor at timing corresponding to a control signal.

By using the above components, not only the above FFT circuit 10 but also a FFT circuit by which the same effect is obtained is realized.

According to the disclosed fast Fourier transform circuit, FFT can be performed on plural pieces of stream data by a small-scale circuit.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A fast Fourier transform circuit comprising:
a multiplexer which receives a plurality of data streams transmitted in parallel on a time axis and which outputs partial data of each data stream every unit time in determined data stream order;
a plurality of delay sections which delay and output input data;
butterfly computation sections which correspond to the plurality of delay sections in number, each of which receives output data from a corresponding delay section as first input data, each of which computes a sum of and a difference between the first input data and second input data, and each of which outputs one computation result or the second input data to the corresponding delay section; and
multiplication sections each of which multiplies an other computation result obtained by each of the butterfly computation sections or output data from the corresponding delay section and a twiddle factor together and each of which outputs a multiplication result as the second input data for a butterfly computation section at a next stage,
wherein:
the butterfly computation section at a first stage receives as the second input data the partial data outputted from the multiplexer; and
a delay section, of the plurality of delay sections, corresponding to the butterfly computation section at the first stage receives in the data stream order the partial data outputted from the multiplexer, delays the partial data, and outputs the partial data as the first input data for the butterfly computation section at the first stage.

2. The fast Fourier transform circuit according to claim 1, wherein delay time is set in each of the plurality of delay sections according to a number of the plurality of data streams and a number of pieces of partial data so that the first input data including partial data which belongs to a same data stream where partial data included in the second input data belongs, together with the second input data, is inputted to each butterfly computation section.

3. The fast Fourier transform circuit according to claim 1, further comprising:
a multiplier circuit which receives a clock signal having a cycle obtained by multiplying the unit time by a number of the plurality of data streams and which generates a multiplied clock signal by multiplying a frequency of the clock signal by the number of the plurality of data streams;
a counter which generates a selection signal for the multiplexer updated in a cycle of the multiplied clock signal and which generates a control signal obtained by frequency-dividing the multiplied clock signal by the number of the plurality of data streams; and
a twiddle factor generation section which updates the twiddle factor at timing corresponding to the control signal.
